(19) United States
(12) Patent Application Publication
(10) Pub. No.: US 2006/0169426 A1
(43) Pub. Date: Aug. 3, 2006

(54) Durable insect screen with improved optical properties

(76) Inventors: Gordon L. McGregor, Landenberg, PA (US); Thomas R. Bugg, Glen Mills, PA (US); David J. Welch, Landenberg, PA (US)

Correspondence Address: GORE ENTERPRISE HOLDINGS, INC., 551 PAPER MILL ROAD, P. O. BOX 9206, NEWARK, DE, 19714-9206, US

(21) Appl. No.: 11/355,879

(22) Filed: Feb. 16, 2006

Related U.S. Application Data
(63) Continuation of application No. 10/779,536, filed on Feb. 13, 2004, now abandoned.
Application No. 10/779,536 is a continuation-in-part of application No. 10/405,104, filed on Mar. 31, 2003, now abandoned.

(51) Int. Cl. E06B 9/24

(52) U.S. Cl. 160/371

(57) ABSTRACT

The present invention is an insect screen with improved durability designed to serve the primary purpose of keeping out very small insects and pests while maximizing visual clarity, light transmission, and airflow. The insect screen is free from macroscopic permanent deformation when subjected to a blunt instrument deformation test of at least 5 lbs. and has a total light transmission of at least 65%. The inventive insect screen comprises fibers in a warp and fill construction which define openings having a warp dimension and a fill dimension, both of said warp and fill dimensions being equal to or less than about 0.06 inches and equal to or larger than about 0.01 inches, the fibers having a diameter less than about 0.007 inches.

### RELATED APPLICATIONS

This application is a continuation of U.S. patent application Ser. No. 10/779,536, filed Feb. 13, 2004, which is a continuation-in-part of U.S. patent application Ser. No. 10/405,104 filed Mar. 31, 2003.

### FIELD OF THE INVENTION

The present invention relates to screens, and more particularly, to woven insect screens.

### BACKGROUND OF THE INVENTION

Insect screens have been in use on windows and doors for more than a century. Their intended purpose is to keep out common insects such as flies, moths, mosquitoes, and bees as well as other creatures such as birds and rodents. Insect screens are used for many applications such as windows, doors, patio enclosures, pool enclosures, garage doors, and more.

Insect screens are typically woven from various types of fibers, historically starting from materials such as horsehair and linen. For greater durability, screens evolved to woven wire made of low-carbon steel, however, the steel was known to rust. Bronze, stainless steel, and aluminum wire replaced steel. In the 1970's, screens woven from vinyl (PVC) coated fiberglass fibers were introduced. These screens offered benefits of durability, light weight, ease of weaving, and ease of installation. Vinyl coated fiberglass screens offered a significant improvement over metal screens for ease of installation since common tools can cut and trim the screen materials without leaving sharp wires that can create safety issues. Vinyl coated fiberglass screens have become the industry standard for common insect screens.

Insect screens are primarily designed to exclude insects from an enclosed area while still offering the sensation of the outdoors by transmitting light, sound, and airflow. However, the basic woven fiber construction of a screen will inherently compromise visibility and airflow due to blockage of open area by the fibers. Visual quality can be expressed in terms of both light transmission as well as clarity. Light transmission relates to the quantity of light that passes through the screen. Clarity is a measure of image distortion cause by the interference of the fibers with the visual image as viewed through the screen. Woven screens can also restrict airflow causing reduced ventilation and reduced sensation of “feeling the breeze.”

Insect screen constructions have been optimized over the years in order to reach a compromise between excluding most insects and enabling reasonable visibility and airflow. Typically, the most common insect screens used today include 16×16, 18×14, 18×16, and 18×18 meshes of plain weave construction. “Mesh” describes the number of openings and fractional parts of an opening per linear inch. With a plain weave, mesh count typically corresponds with the fiber count for number of fibers per inch in the warp and fill. With increased mesh or fiber count, the opening or hole size decreases with fiber diameter remaining constant. In certain geographical regions where small biting midges and sand flies, also known as “no-see 'ums”, are present, 20×20 mesh screening is recommended to offer exclusion of these insects. However, the tradeoff for excluding small insects, such as midges, is not only a reduction in visual quality but also a reduction in airflow due to the loss of open area from the increased number of fibers. For example, to compensate for the loss of airflow caused by a 20×20 mesh screen, it is recommended to double the amount of screen surface area used for ventilation in order to equal the amount of unscreened window normally used; i.e., two screened open windows are required to equal the airflow of one unscreened open window.

Although the term mesh is typically used to describe the relative hole size of woven screening, this term gives no recognition to the diameter of the fiber or wire, and thus the mesh number does not always have a relationship to the size of the hole in the screen. Hole size, aperture, or opening is defined as the dimension between adjacent parallel wires, usually expressed in decimal parts of an inch. It can be calculated using the equation below for each of the warp and fill directions of the screen. Fill is defined as fibers or wires running across the width or short way of the woven cloth during weaving, also referred to as shute and weft. Warp is defined as the fibers of wire running lengthwise during weaving.
Opening=(1/N)−D
N=Wires per inch
D=Wire diameter (inches)

This equation remains accurate for screens woven from wire and fibers where the diameter of the material is unchanging. In the case of PVC coated fiberglass, the coating can melt flow during processing thereby changing the original fiber dimensions. The above formula can be used for these materials as well providing that the fiber diameter is measured in the final state assuming uniform fiber size and parallel fibers.

When comparing screens of different materials and constructions, it is important to make these comparisons using similar opening or hole size dimensions since the opening dimension provides the critical dimension for insect exclusion. Typically, insect screens can be defined by the fiber material, fiber diameter, and weaving construction (mesh or fibers per inch).

In order to understand the opening size commonly used in insect screening, a sampling of various commercial insect screens was compared. The properties and calculated openings are shown in the table below. Calculations in the table assumed mesh and fiber count to be identical. In addition to commercial screens, also included are examples of insect wire screens specified as American National Standards approved by the Insect Screening Weavers Association in 1990 document ANSI/IWS 089-1990.

| Supplier | Material | Mesh | Wire Dia (In) | Warp Opening (in) | Fill Opening (in) |
|---|---|---|---|---|---|
| Connecticut Screen | PVC-Fiberglass | 20 × 20 | 0.013 | 0.0370 | 0.0370 |
| Works | | | | | |
| Connecticut Screen | PVC-Fiberglass | 18 × 14 | 0.013 | 0.0426 | 0.0584 |
| Works | | | | | |
| Wright Screens, | PVC-Fiberglass | 18 × 16 | 0.011 | 0.0446 | 0.0515 |
| LLC | | | | | |
| American National | Aluminum | 18 × 16 | 0.011 | 0.0446 | 0.0515 |
| Standard | | | | | |
| American National | Bronze | 18 × 14 | 0.011 | 0.0466 | 0.0604 |
| Standard | | | | | |
| American National | Carbon Steel | 18 × 14 | 0.009 | 0.0466 | 0.0624 |
| Standard | | | | | |
| Marco Specialty | Galvanized Steel | 18 × 14 | 0.009 | 0.0466 | 0.0624 |
| Steel | | | | | |
| Marco Specialty | Bronze | 18 × 14 | 0.011 | 0.0466 | 0.0604 |
| Steel | | | | | |
| TWP Inc. | Stainless Steel | 18 × 14 | 0.009 | 0.0466 | 0.0624 |
| TWP Inc. | Copper | 16 × 16 | 0.011 | 0.0515 | 0.0515 |

As evidenced by the examples in the table, fiber or wire commonly used for window insect screening is known to have diameters ranging from 0.009 to 0.013 inches. It is important to note that the calculated hole width for the fiberglass screens used the indicated wire diameter as opposed to the actual wire diameter in the finished screen. Hole size and open area of PVC coated fiberglass screens typically have values less than the expected values due to flow of the PVC coating.

Various polymeric materials have been used for specialized greenhouse screening. This type of screening is used for the purposes of restricting very small insects and thereby negating the need to use pesticides. These screens are typically woven from small diameter polyethylene and nylon fibers into tight screen constructions to have very small hole sizes of less than 0.02 inches. These screens can be purchased from Green-tek under the names No-Thips and Virus Vector screens. These types of insect screens are not intended for residential insect screen applications because of poor visual clarity characteristics and limited airflow. Furthermore, fiber materials such as polyethylene and nylon are known to have poor UV radiation (sunlight) resistance, which can degrade the fiber strength over time. Thus, polyethylene and nylon screens are typically limited to a lifetime of three years or less. The lifetime of residential screens is expected to be many years, often five, ten, or more. For these reasons, polyethylene and nylon are not used as insect screens for windows, doors, patios, and other residential applications.

Typically, insect screens have either the warp or fill hole dimension to be less than about 0.05 inches in order to exclude most common flying insects, with the other hole dimension being larger than about 0.03 inches in order to offer acceptable airflow, visual clarity, and/or light transmission. In other words, the warp and fill dimension are not both below about 0.03 inches, nor are they both above about 0.05 inches. This hole size range for residential window screening is consistent with products offered and sold as window/insect screen. One example of screen sold for insect exclusion with a hole size larger than 0.05 inches in both the warp and fill dimensions is made of copper wire with a 16×16 mesh as described in the table above. This screen uniquely offers a historically accurate aesthetic appeal and does not fall into the hole size ranges depicted by the American National Standards of the Insect Screening Weavers Associations.

It has been recognized that optical attenuation and light distortion of window screens can be undesirable. U.S. Pat. No. 5,139,076 describes a distortion free window screen made from transparent fiber optic cables. It is the intention of this patent to increase the light transmission of the screen while minimizing distortion of the light passing through the fibers. They attempt to accomplish this by using clear, round cross-section, fibers. Although the total light transmission can be improved with clear fibers, distortion and glare will still exist due to reflection and refraction of the light rays through the clear fiber.

Another attempt to minimize the drawbacks of screen see-through visibility is described in U.S. Pat. No. 5,392,835. This patent describes a roll-type retractable insect screen that can be retracted when not in use. This type of technology enables the user to remove the screen from the field of view when not in use so as to provide a clear unobstructed view.

There are long-felt needs associated with current insect screen technology. These include the needs for improvement to optical transmission characteristics and airflow characteristics. In particular, there has been a long-felt need in the industry for an “invisible screen,” one that is less visible and hence less obstructive of the view through the screen. It is surprising that using smaller fibers for the screen construction would be effective because more fibers would be needed to provide the same hole sizes, thus not providing any real improvement in visibility.

### SUMMARY OF THE INVENTION

The present invention is an improved insect screen designed to serve the primary purpose of keeping out insects and pests while maximizing visual clarity, light transmission, and airflow with improved durability.

One aspect the present invention is an insect screen comprising fibers, the insect screen having a total light transmission of at least 65% and, preferably, total light transmission of at least 70% and at least 80%; and which insect screen undergoes no macroscopic permanent deformation when subjected to a blunt instrument deformation test of at least about 1.0 lbs. and, preferably, at least about 2.0 lbs., at least about 3.0 lbs., at least about 4.0 lbs. and at least about 5.0 lbs. Preferably, the insect screen is constructed of fibers comprising a fluoropolymer. More preferably the fibers are constructed of PVDF.

In another aspect, the invention provides an insect screen comprising fibers, the insect screen having a visual clarity factor of at least 60% and, preferably, a visual clarity factor of at least about 70% and at least about 80%; and which undergoes no macroscopic permanent deformation when subjected to a blunt instrument deformation test of at least about 0.5 lbs. and, preferably, at least about 1.0 lbs. and, preferably, at least about 2.0 lbs., at least about 3.0 lbs., at least about 4.0 lbs. and at least about 5.0 lbs. Preferably, the insect screen is constructed of fibers comprising a fluoropolymer. More preferably, the fibers are constructed of PVDF.

In another aspect, the insect screen comprises of fibers in a warp and fill construction defining openings having a warp and fill dimension, at least one of the warp and fill dimensions being less than about 0.06 inches and the other of the warp and fill dimensions being larger than about 0.01 inches.

In still another aspect, the insect screen is constructed of fibers that are opaque.

In yet another aspect, the insect screen is constructed of fibers that are clear.

In a further aspect, the insect screen is constructed of fibers that are dark in color.

In another aspect, the present invention provides a method of excluding insects from a space having an access comprising the steps of: providing a frame; mounting fibers in the frame in a warp and fill construction defining openings having a warp and fill dimension, at least one of the warp and fill dimensions being less than about 0.06 inches and the other of the warp and fill dimensions being larger than about 0.01 inches, to form a screen, the fibers comprising PVDF and having a diameter equal to about 0.005 inches, whereby the screen has a total light transmission of at least about 65% and, preferably, a total light transmission of at least about 70%, and at least about 75% and at least about 80%, and is free of macroscopic permanent deformation when subjected to a blunt instrument deformation test of about 5 lbs. or less; and covering the access with the screen, whereby the insects are prevented from entering the space.

In another aspect, the present invention provides a method of excluding insects from a space having an access comprising the steps of: providing a frame; mounting fibers in the frame in a warp and fill construction defining openings having a warp and fill dimension, at least one of the warp and fill dimensions being less than about 0.06 inches and the other of the warp and fill dimensions being larger than about 0.01 inches, to form a screen, the fibers comprising PVDF and having a diameter equal to about 0.005 inches, whereby the screen has a visual clarity factor of at least about 75% and, preferably, a visual clarity factor of at least about 70% and at least about 80%, and is free of macroscopic permanent deformation when subjected to a blunt instrument deformation test of about 5 lbs. or less; and covering the access with the screen, whereby the insects are prevented from entering the space.

In another aspect, the present invention provides a method of excluding pests from a space having an access comprising the steps of: providing a frame comprising a groove and spline construction; mounting fibers in said frame in a warp and fill construction defining openings having a warp and fill dimension, at least one of said warp and fill dimensions being less than about 0.06 inches and the other of said warp and fill dimensions being larger than about 0.01 inches, to form a screen, said fibers comprising PVDF and having a diameter equal to about 0.005 inches, whereby the screen has a visual clarity factor of at least about 75% and is free of macroscopic permanent deformation when subjected to a blunt instrument deformation test of about 5.0 lbs. or less; and covering the access with said screen, whereby the pests are prevented from entering the space.

### BRIEF DESCRIPTION OF THE DRAWING

FIG. 1 is an oblique cross-sectional view of an embodiment of the present invention.

FIG. 2 is a schematic of a device used to measure the optical properties of the present invention.

FIG. 3 is a schematic of a device used to measure the durability of the present invention.

### DETAILED DESCRIPTION OF THE INVENTION

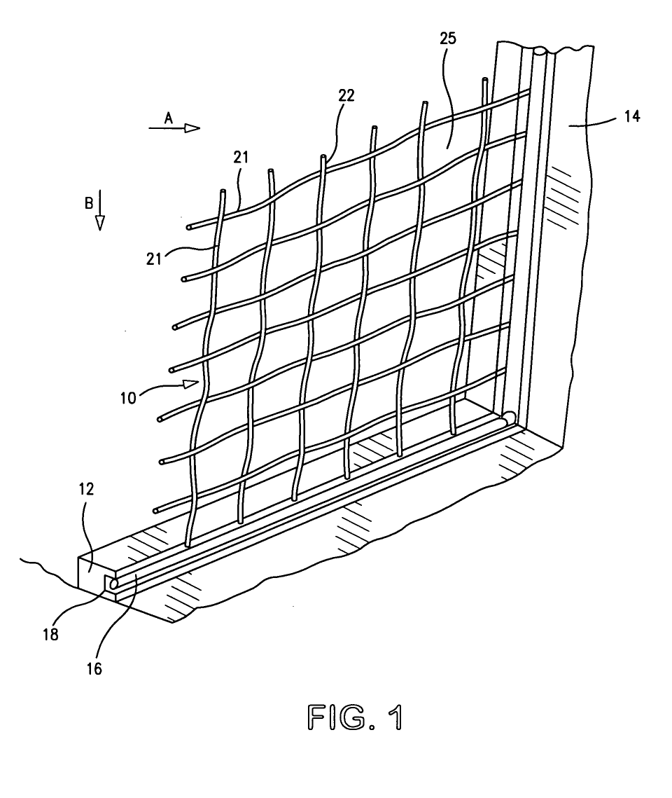

The present invention is an improved insect screen material with remarkable light transmission and airflow properties and improved durability. An embodiment of the present invention is illustrated in FIG. 1. An insect screen 10 is shown, formed of fibers 21. Fibers 21 are woven into a warp and fill construction. In this embodiment, the warp dimension is designated by arrow A, the fill dimension by arrow B, although these directions could of course be reversed, depending on the direction of weaving. Fibers 21 intersect at intersections 22, and define openings 25. Screen 10 is preferably mounted in a frame 12 attached to a structure 14. Frame 12 preferably has a spline 16 and a groove 18 construction for securely attaching screen 10 thereto.

In a preferred embodiment, this invention involves the use of fibers with diameters of about 0.007 inches or less woven into an insect screen having a particular hole size and construction. In other preferred embodiments, the fibers have diameters of less than about 0.006 inches, less than about 0.005 inches, less than about 0.004 inches, less than about 0.003 inches, to about 0.002 inches. By using fibers that are significantly smaller than current insect screen fibers, the light transmission and airflow increases substantially. Furthermore, by decreasing the fiber diameter, the fibers tend to become less visually apparent, thus creating an insect screen that is much more visually appealing.

In one aspect, the screens of the present invention can be of a variety of fiber materials. These materials can include, but are not limited to, standard metal materials such as aluminum, steel, bronze, copper, and stainless steel. These materials can also include non-metallic materials such as polyester, nylon, PVC coated fiberglass and others.

A factor that can affect screen durability is ultraviolet (UV) degradation, typically caused by sunlight exposure. It is known that most non-metallic fibers will degrade and lose strength after a few years of sunlight exposure due to UV degradation. PVC coated fiberglass screens exhibit this degradation with the PVC coating turning white and flaking off. It can be desirable to use non-metallic fibers as a screen material, but it becomes challenging to meet durability expectations if small fibers are used. Small diameter fibers already can be weaker in breakstrength than larger diameter fibers and with further UV degradation the fiber can fail prematurely. With these limitations, it is challenging for small diameter non-metallic insect screens to meet the typical industry expectations for lifetimes of five to ten years or more.

A novel aspect of the present invention is that in a preferred embodiment it incorporates the use of fluoropolymer fibers as the primary fiber for woven insect screen. Fluoropolymers offer a unique advantage for this application since they typically have extremely low UV light absorption, which enables the material to remain virtually unaffected when exposed to these often harmful wavelengths. Fluoropolymers that may be suitable for this application include, but are not limited to, fluoropolymers in the classes of ethylene tetrafluoroethylene (ETFE), ethylene chlorotrifluoroethylene (ECTFE), polytetrafluoroethylene (PTFE), fluorinated ethylene propylene (FEP), perfluoroalkoxy (PFA), tetrafluoroethylene perfluoromethylvinylether (MFA), tetrafluoroethylene hexafluoropropylene vinylidene fluoride (THV), polyetheretherketone (PEEK), and polyvinylidene fluoride (PVDF). Attributes that should be considered in material selection include strength, elongation, modulus, and processibility.

One of the preferred fluoropolymer fiber materials of this invention is PVDF. This material is readily melt processible thereby enabling fibers of uniform small diameters to be cost effectively fabricated. This material is also one of the stronger fluoropolymer materials thus offering enhanced durability. Also, this material can be bonded to itself through various bonding techniques thus being able to produce a preferable insect screen fabric where a substantial number of the fibers are bonded at their intersection points for improved stability.

Insect screens are typically manufactured by weaving monofilament or multifilament fibers using standard weaving processes. Weaving constructions can include plain, twill, satin, and others such as the leno weave. The most popular weave for metal and PVC coated fiberglass screens is the plain weave. This construction offers a simple cost effective process for fabricating an insect screen. One disadvantage of the plain weave is that the fiber construction can be loose and unstable depending on the openness of the fabric and rigidity of the fiber. PVC coated fiberglass screens overcome this issue by melt flowing the PVC coating to adhere the fibers at the intersections.

Another aspect of this invention is an insect screen of a non-metallic material that is bonded at the fiber intersections. Durably bonding polymer fibers can be particularly challenging. Adhesives can be used, however, excess adhesive may be inadvertently applied beyond the fiber intersections regions. Furthermore, adhesives tend not to be UV resistant. Another bonding approach is to use heat for melt bonding fiber at the intersections. This technique can be accomplished through various processing options, one of which uses heated calendering rolls. With this approach, special care needs to be taken to avoid melting the entire fiber outside of the intersection points regions. This melting can cause the fiber cross-section to flow and flatten resulting in a screen that has less light transmission and airflow. This problem is evident with PVC coated fiberglass insect screens in that the PVC coating flows during the thermal bonding process, which decreases the dimensions of the warp and fill openings. The result is a significant loss of 10% or more in light transmission yielding a screen of only about 55% light transmission. This bonding issue is typically limited to non-metallic insect screens since the fibers of metal screens tend to offer a more rigid and stable weave thereby negating the need for bonding of the fibers.

An inventive preferable method of bonding non-metallic fibers is through the use of ultrasonic energy. Heat can be generated locally at the fiber intersections by applying ultrasonic energy through an ultrasonic horn and anvil system. This process can be accomplished when the fabric is stationary using a plunge and activate method. Preferably, it may be accomplished in a continuous process using a horn and rotary anvil. Use of ultrasonics for bonding fibers in insect screens has unique inventive advantages. Since the process can generate heat for bonding isolated only to the fiber intersections, bonding can occur without heating the entire fiber. By controlling the applied heat, the fiber shape is less likely to distort. The result is a screen of fibers that substantially maintain the original cross section of the fibers in the non-bonded, non-intersecting regions. The end result is an insect screen that is substantially stable due to the bonds at fiber intersection, with very little flow of the fibers elsewhere. This non-metallic screen construction can offer higher light transmission and visual clarity properties than previously achieved.

Insect screens are available in a variety of colors ranging from black to green to white. Metal screens are typically painted or coated for color and corrosion resistance. It has been found that a darker color such as black is preferable in order to reduce reflective glare. Furthermore, a fiber that is opaque can reduce the transmitted refractive glare. Clear fibers can increase the total light transmission of a screen fabric but can suffer from reflective and refractive glare in certain applications.

Another aspect of this invention is an insect screen material that is suitable for mounting in a screen frame using a conventional spline and groove attachment. The majority of insect screens used in combination with window frames utilize this method for mounting and attachment. It is preferable that the screen construction enables this means for mounting and attachment.

Without intending to limit the scope of the present invention, the following examples illustrate how the present invention may be made and used.

### EXAMPLE 1

An insect screen was fabricated in the following manner: PVDF fiber was extruded using standard methodologies known in the industry.

For this example, Albany International, of Albany N.Y., extruded fiber at a diameter of 0.005 inches. This fiber had an average denier of 242 and average tenacity of 3.22 grams per denier. Clear fiber was extruded.

The fiber was then woven into a plain weave construction using standard weaving techniques. For this example, Prodesco of Perkasie Pa. provided the weaving. The fiber was woven into a 52 inches wide construction screen having 20 picks per inch (ppi) by 17 picks per inch (ppi). The warp and fill openings (hole sizes) were measured to be 0.046″ and 0.053″ respectively.

This woven screen was then tested for light transmission properties. The results are listed in the table below.

### EXAMPLE 2

Insect screen from Example 1 was then lightly painted with black semigloss spray paint. The paint used was Painter's Touch #1974 by Rust-oleum Corporation. The purpose of this paint was to simulate a black opaque fiber in order to conduct light transmission testing. This painted woven screen was then tested for light transmission properties. The results are listed in the table below.

The following method was used to evaluate light transmission properties for inventive and comparative insect screen materials. The comparative insect screen materials of PVC fiberglass (11 mil−18×14) (Comparative Example 1) and stainless steel (9 mil−18×14) (Comparative Example 2) were from New York Wire Co., Mt. Wolf, Pa. and TWP Inc., Berkeley, Calif. respectively.

Light Transmission Testing

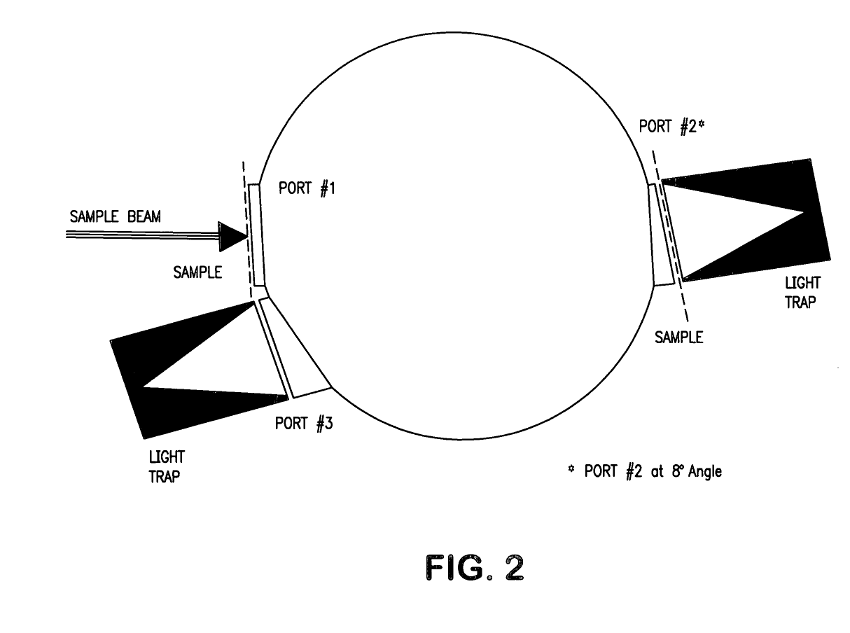

The procedure to measure the optical properties of a screen material makes use of a spectrometer, specifically a Perkin Elmer Lambda 18 model suitable for measurements in the visible range of wavelengths. The spectrometer must have the capability to measure integrated reflectivity and transmission via an integrating sphere attachment like, for example, model RSA-PE-18 from Labsphere. The values obtained here require four different configurations: Specular+diffuse transmission (total transmission), Specular+diffuse reflectance (total reflectance), diffuse-only transmission and diffuse-only reflectance. The results are recorded in each instance in absolute percentages. With reference to FIG. 2, three ports on the integrating sphere are of importance: The first port is the light entry and transmission port (port 1). The reflectance port (port 2) is used for a 100% calibration as well as reflectance measurements. Its surface normal is at an angle (8 degrees) versus the sample beam, which allows for capture of a specularly reflected beam at the specular port (port 3). Port 1, 2 and 3 include an angle of 16 degrees. The beam size in port 1 and 2 should be significantly larger than the openings in the screen to minimize measurement errors due to edge effects. The beam size used was about ⅜×⅛ inches.

In Specular+Diffuse transmission mode, the sample is placed in port 1 and transmission of the beam in the forward direction (specular) as well as all hemispherically scattered transmission is recorded simultaneously. A 100% standard must be placed in port 2. For the diffuse-only transmission, the specular component of the transmitted light needs to be trapped by a light trap placed in port 2 with the sample in port 1.

Diffuse+Specular reflectance is measured by placing the sample into port 2. Care must be taken (since reflectance can be quite low) that a light trap is placed behind the sample so that any light, transmitted through the sample, cannot return back into the sphere via port 2. Appropriate background subtraction procedures should be applied. A measurement of diffuse reflectance eliminates specularly reflected light by placing another light trap into port 3 while having the sample, backed by a light trap, in port 2. This will measure only that light which is diffusely reflected into the intergrating sphere. Specular-only reflectance is calculated by subtracting diffuse-only reflectance from total reflectance.

Specular transmission is meant to depict the direct light that passes through the screen openings excluding diffuse transmission and the reflective components. This direct light represents the undistorted light emitted by the image to be viewed. This value was calculated by the following equation:
Specular transmission=total transmission−(diffuse transmission only)

Visual clarity factor is meant to describe the specular transmission of the image to be viewed through the screen while taking into account the negative effects of glare associated with the diffuse transmission as well as both the diffuse and specular reflective light components. This value was calculated by the following equation:
Visual clarity factor=Specular transmission−(diffuse transmission only+total reflectance)

The results of the testing are shown in the table below:

| | | | | | | | | Visual Clarity |
|---|---|---|---|---|---|---|---|---|
| | Total | | | | | Specular | | Factor |
| | Transmission | Diffuse | | | | Transmission | | Spec Trans − |
| | Transmission | Transmission | Total | Reflectance | Reflectance | Transmission | Diff Trans + | (Diff Trans + |
| | Diff + Spec | Only | Reflectance | Diffuse only | Spec only | Spec Only | Reflectance | Reflectance) |
| 5 mil PVDF - | 96.7% | 14.5% | 1.7% | 1.6% | 0.1% | 82.2% | 16.2% | 66.0% |
| clear (Ex. 1) | | | | | | | | |
| 5 Mil PVDF - | 81.4% | 1.3% | 0.7% | 0.6% | 0.1% | 80.1% | 2.0% | 78.1% |
| Black (Ex. 2) | | | | | | | | |
| 11 mil PVC | 56.0% | 0.8% | 2.5% | 2.0% | 0.5% | 55.2% | 3.3% | 51.9% |
| fiberglass - black | | | | | | | | |
| 9 mil stainless | 74.3% | 3.1% | 9.3% | 9.0% | 0.3% | 71.2% | 12.4% | 58.8% |
| steel | | | | | | | | |

As can be seen from the table above, the visual clarity of the working examples, demonstrated by the visual clarity factor, is considerably better than the comparative examples. This is quite a surprising result, because the hole sizes are similar in all the examples (working and comparative), and the pick count is higher with the working examples. Because the inventive screens have such better visual clarity, they are much more desirable for the industry, fulfilling the long-felt need for screens with better visual characteristics.

For many screen applications such as windows, doors, screened porches, tents, and more, a special construction of screen may be required for substantial exclusion of insects that are smaller than typical insects such as houseflies and mosquitoes. This insect category includes smaller insects such as biting midges, known as “noseeums” or Ceratopogonidae, but also includes even smaller insects commonly found in areas near lakes, rivers, or farms. It can be desirable to exclude these insects from residential applications, recreational vehicles, screened in porches, tents, etc. while still retaining the visual and airflow benefits that insect screens are designed to offer.

Insect screens having hole dimensions of 0.040 inches will exclude some portion of these smaller insects. However, by decreasing hole dimensions further to 0.030 inches, 0.020 inches, 0.010 inches, and even smaller, one can obtain substantial exclusion of even smaller insects. At these smaller hole sizes in today's commercial screens, it is well known that there are significant performance compromises through reduced visual clarity, light transmission, and air flow. Typical commercial examples of residential insect screens offering “no-see 'um” exclusion are specified having a 20×20 or 20×30 mesh.

An aspect of this invention includes the use of small diameter fibers to construct an insect screen which has small hole dimensions for tiny insect exclusion yet still offers exceptional visual clarity, light transmission, air flow and durability. It is surprising that by combining small fibers having diameters equal to or less than about 0.007 inches with hole dimensions of equal to or less than about 0.06 inches and equal to or larger than about 0.01 inches, an inventive screen can be produced which far exceeds the performance of conventional screens.

Without intending to limit the scope of the present invention, the following examples illustrate how the present invention may be made and used.

### COMPARATIVE EXAMPLES 3 & 4

Screen material was purchased from Connecticut Screen Works in Northford, Conn. Two screen materials were available for excluding smaller “no-see 'um” type of insects. Comparative Example 3 is a PVC coated fiberglass, 20×20 mesh with 0.013-inch fiber diameter. Comparative Example 4 is a PVC coated fiberglass, 20×30 mesh with 0.015-inch fiber diameter.

These screen materials were measured for wire diameter and warp and fill opening dimensions. These measurements are shown in the table below. This screen material was also tested for light transmission properties; the results also listed in the tables below.

### INVENTIVE EXAMPLES 3 & 4

Inventive insect screen was fabricated in the following manner:

PVDF fiber was extruded using standard methodologies known in the industry. For this example, fiber was extruded at a diameter of 0.003 inches. This fiber had an average denier of 85 and average tenacity of 4.3 grams per denier. Black fiber was extruded.

The fiber was then positioned into a mock weave construction using a fixturing device. This fixture enabled fibers to be placed parallel to each other at a count of 42 fibers per inch. Opposing fibers were positioned perpendicular to the first fibers, also at 42 fibers per inch. The resulting mock weave had square holes that measured to be 0.020 inches per side. This is Inventive Example 3. This basic fabric construction could be accomplished though various means including standard weaving practices. In this example, the fibers were not interwoven, however, it should be appreciated that fibers could be fused at their intersections if further stabilization were required. It should be further appreciated in the event the basic fabric construction is not made by weaving, the terms “warp” and “fill” nonetheless apply to designate respective, relatively perpendicular directions.

Using the above procedure, Inventive Example 4 was produced using the same fiber diameter of 0.003 inches, however the fiber count was 21 fibers per inch for both the warp and fill. The resulting holes were square with dimensions of 0.043 inches.

Example: Comparative and Inventive Screen Materials

| | | | | | Measured | Measured |
|---|---|---|---|---|---|---|
| | | | Specified | Measured | Warp | Fill |
| | | | Wire Dia | Wire Dia | Opening | Opening |
| Supplier | Material | Mesh | (In) | (In) | (in) | (in) |
| Comparative | PVC-Fiberglass | 20 × 20 | 0.013 | 0.018 | 0.033 | 0.033 |
| Example 3 | | | | | | |
| Comparative | PVC-Fiberglass | 20 × 30 | 0.015 | 0.018 | 0.033 | 0.018 |
| Example 4 | | | | | | |
| Inventive | PVDF | 42 × 42 | 0.003 | 0.003 | 0.020 | 0.020 |
| Example 3 | | | | | | |
| Inventive | PVDF | 21 × 21 | 0.003 | 0.003 | 0.043 | 0.043 |
| Example 4 | | | | | | |

The above examples were then tested for light transmission properties using the methodology described previously in this patent. The results are depicted in the following table:

| | | | | | | | | Visual |
|---|---|---|---|---|---|---|---|---|
| | | | | | | | | Clarity |
| | Total Transmission | | | | | Specular Transmission | | Factor |
| | | Diffuse | | | | | Diff | Spec Trans − |
| | Transmission | Transmission | Total | Reflectance | Reflectance | Transmission | Trans + | (Diff Trans + |
| | Diff + Spec | Only | Reflectance | Diffuse only | Spec only | Spec only | Reflectance | Reflectance) |
| Comparative Example 3 (20 × 20) | 43.4% | 0.7% | 2.5% | 2.4% | 0.1% | 42.7% | 3.2% | 39.5% |
| Comparative Example 4 (20 × 30) | 32.3% | 0.6% | 2.9% | 2.9% | 0.0% | 31.7% | 3.5% | 28.2% |
| Inventive Example 3 (42 × 42) | 74.7% | 1.3% | 0.7% | 0.6% | 0.1% | 73.4% | 2.0% | 71.4% |
| Inventive Example 4 (21 × 21) | 87.4% | 0.5% | 0.4% | 0.4% | 0.0% | 86.9% | 0.9% | 86.0% |

As can be seen from the table, the light transmission and visual clarity of the inventive examples, is considerably better than the comparative examples. This is quite a surprising result, because the hole sizes are similar in all the examples (working and comparative), and the pick count is higher with the working examples. Because the inventive screens have such better visual clarity, they are much more desirable for the industry, fulfilling the long-felt need for screens with better visual characteristics.

Permanent Deformation

One additional challenge with developing insect screens with high light transmission and visual clarity is durability. Insect screens are subjected to many mechanical forces that can cause permanent deformation to the screen fabric. These forces can be associated with manufacturing processes, influences during shipping, installation and storage, and forces applied during actual use. Examples of these mechanical forces include framed screens leaning against each other, objects such as patio furniture leaning against screens, a broom stick grazing the screen, humans pushing on the screen, birds flying into the screen, and many others.

Permanent deformation to an insect screen with improved optical properties can be particularly troublesome. These inventive insect screens are valued for their visual appearance so any changes to their appearance are highly undesirable. Permanent deformation such as dents, grooves, and depressions can be readily observed in an otherwise invisible screen as it detracts from the improved optical properties. Therefore insect screens which can inherently resist permanent deformation due to mechanical forces are highly desirable, and this is particularly important for insect screens with improved optical properties.

As used herein, “macroscopic permanent deformation” of an insect screen is defined as a physical change to the planarity of the insect screen fabric observable by the unaided eye and which remains in the insect screen until an additional external force is applied.

There are many methods that can be devised for testing and evaluating permanent deformation. The following describes a test apparatus and method for evaluating the inventive material and comparative examples:

Deformation Test Apparatus and Test Method

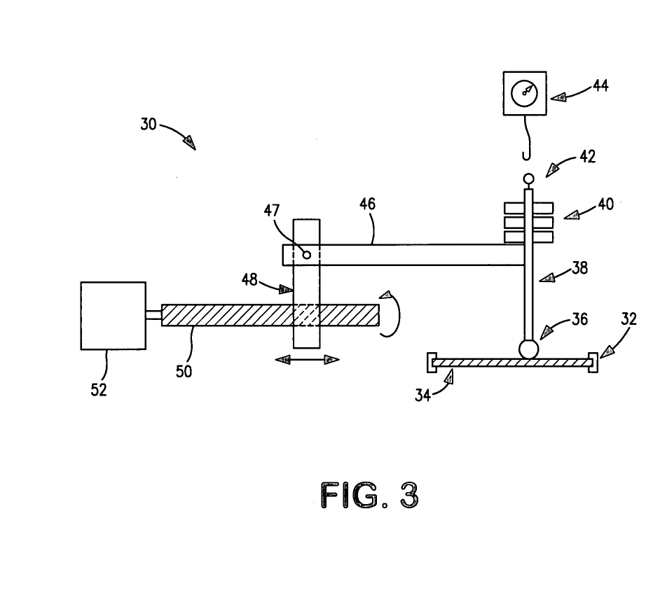

FIG. 3 shows the deformation test apparatus used. The test apparatus 30 is used to apply force on insect screen fabric 34 to test for permanent deformation. Samples of insect screen fabric 34 are tested in a standard spline and groove frame 32. A probe 38 is placed against the insect screen fabric 34 via a probe tip 36. For this test, the probe tip is a 0.26 inch diameter polished chromed steel ball. The probe tip is weighted with various weights 40. The normal force of the probe 38 against the insect screen fabric 34 can be measured by using the force gage 44. The force gage 44 is hooked to the eyelet 42 to measure the force before each test. After measurement, the force gage is unhooked. During the test, the probe tip 36 is dragged across the insect screen fabric 34 via the pivot bar 46, the pivot 47, the actuator bar 48, the worm screw 50, and the motor 52.

For this test, the actuator bar 48 is driven at a rate of 17 inches per minute for a 3 inch pass. A single pass is conducted on a sample at a given force on the probe tip 36. The insect screen samples are evaluated after each pass both visually and by touch to determine if any permanent deformation is evident that is significant enough to be observed by the human eye. Permanent deformation that is observed by the unaided human eye is considered to be macroscopic permanent deformation. Typically, for this test, the deformation is evident in the form of an indented line or groove. The following materials were tested:

### COMPARATIVE EXAMPLE 5

An insect screen sample was fabricated from a stainless steel mesh having 50×50 picks per inch with a fiber diameter of 0.0012 inches (1.2 mils). This mesh is commercially available from TUVP, Inc of Berkley, Calif.

### COMPARATIVE EXAMPLE 6

Another insect screen was fabricated from type 304 stainless steel woven mesh purchased from TWP having 18×18 picks per inch with a fiber diameter of 0.005 inches (5 mil).

### INVENTIVE EXAMPLE 5

5 mil diameter PVDF black pigmented fiber was woven into a 32 inch wide construction having 20 picks per inch (ppi) by 17 picks per inch (ppi). The warp and fill openings (hole sizes) were measured to be 0.046″ and 0.053″ respectively. The woven fabric was subsequently bonded at the fiber overlaps using a continuous ultrasonic laminating process commonly used in the industry.

The above three examples were then tested for permanent deformation properties using the methodology described previously in this patent. The results are depicted in the following table:

| Force (lbs.) | Comparative Ex. 5 | Comparative Ex. 6 | Inventive Ex. 5 |
|---|---|---|---|
| 0.1 | Permanent Deformation | No perm. deformation | No perm. deformation |
| 0.3 | Permanent Deformation | Permanent Deformation | No perm. deformation |
| 0.5 | Permanent Deformation | Permanent Deformation | No perm. deformation |
| 0.7 | Permanent Deformation | Permanent Deformation | No perm. deformation |
| 0.9 | Permanent Deformation | Permanent Deformation | No perm. deformation |
| 1.2 | Permanent Deformation | Permanent Deformation | No perm. deformation |
| 2.1 | Permanent Deformation | Permanent Deformation | No perm. deformation |
| 3.3 | Permanent Deformation | Permanent Deformation | No perm. deformation |
| 4.4 | Permanent Deformation | Permanent Deformation | No perm. deformation |
| 5.0 | Permanent Deformation | Permanent Deformation | No perm. deformation |
| 6.3 | Permanent Deformation | Permanent Deformation | Failure - fabric puncture |

Based on the data above, the comparative examples permanently deformed at relatively low force loadings whereas the inventive example did not permanently deform until absolute failure at more than 20 times the loading of the comparative examples. Preferably, an insect screen should be free of macroscopic permanent deformation when subjected to a force of at least about 0.5 lbs., preferably at least about 1 lb., more preferably at least about 2 lbs., still more preferably at least about 3 lbs., even more preferably at least about 4 lbs. and most preferably at least about 5 lbs. It is quite surprising to combine this resistance to macroscopic permanent deformation attribute with the high light transparency and clarity attributes into an insect screen. This invention has benefit for optically improved insect screen of all types including fine mesh screens, no-see 'um screens, as well as screens with larger openings.

While particular embodiments of the present invention have been described herein, the present invention should not be limited to such descriptions. It should be apparent that changes and modifications may be incorporated and embodied as part of the present invention within the scope of the following claims.

The invention claimed is:

1. An insect screen comprising fibers, said insect screen having a total light transmission of at least 65% and being free of macroscopic permanent deformation when subjected to a blunt instrument deformation test of at least about 1.0 lbs.

2. The insect screen according to claim 1, said insect screen having a total light transmission of at least 65% and being free of macroscopic permanent deformation when subjected to a blunt instrument deformation test of at least about 2.0 lbs.

3. The insect screen according to claim 1, said insect screen having a total light transmission of at least 65% and being free of macroscopic permanent deformation when subjected to a blunt instrument deformation test of at least about 3.0 lbs.

4. The insect screen according to claim 1, said insect screen having a total light transmission of at least 65% and being free of macroscopic permanent deformation when subjected to a blunt instrument deformation test of at least about 4.0 lbs.

5. The insect screen according to claim 1, said insect screen having a total light transmission of at least 65% and being free of macroscopic permanent deformation when subjected to a blunt instrument deformation test of at least about 5.0 lbs.

6. The insect screen of claim 1 wherein said fibers have a diameter equal to or less than about 0.007 inches.

7. The insect screen of claim 1 wherein said fibers have a diameter equal to or less than about 0.005 inches.

8. The insect screen of claim 1 wherein said fibers comprise a fluoropolymer.

9. The insect screen of claim 1 wherein said fibers comprise PVDF.

10. The insect screen of claim 1 further comprising a frame having a groove and spline construction, said fibers mounted in said frame.

11. The insect screen of claim 1 where said fibers are opaque.

12. The insect screen of claim 1 where said fibers are clear.

13. The insect screen of claim 1 where said fibers are dark in color.

14. The insect screen of claim 1 further comprising fibers in a warp and fill construction defining openings having a warp and fill dimension, at least one of said warp and fill dimensions being less than about 0.06 inches and the other of said warp and fill dimensions being larger than about 0.01 inches.

15. The insect screen according to claim 1, said insect screen having a total light transmission of at least 70% and being free of macroscopic permanent deformation when subjected to a blunt instrument deformation test of at least about 1.0 lbs.

16. The insect screen according to claim 1, said insect screen having a total light transmission of at least 70% and being free of macroscopic permanent deformation when subjected to a blunt instrument deformation test of at least about 2.0 lbs.

17. The insect screen according to claim 1, said insect screen having a total light transmission of at least 70% and being free of macroscopic permanent deformation when subjected to a blunt instrument deformation test of at least about 3.0 lbs.

18. The insect screen according to claim 1, said insect screen having a total light transmission of at least 70% and being free of macroscopic permanent deformation when subjected to a blunt instrument deformation test of at least about 4.0 lbs.

19. The insect screen according to claim 1, said insect screen having a total light transmission of at least 70% and being free of macroscopic permanent deformation when subjected to a blunt instrument deformation test of at least about 5.0 lbs.

20. The insect screen according to claim 1, said insect screen having a total light transmission of at least 75% and being free of macroscopic permanent deformation when subjected to a blunt instrument deformation test of at least about 1.0 lbs.

21. The insect screen according to claim 1, said insect screen having a total light transmission of at least 75% and being free of macroscopic permanent deformation when subjected to a blunt instrument deformation test of at least about 2.0 lbs.

22. The insect screen according to claim 1, said insect screen having a total light transmission of at least 75% and being free of macroscopic permanent deformation when subjected to a blunt instrument deformation test of at least about 3.0 lbs.

23. The insect screen according to claim 1, said insect screen having a total light transmission of at least 75% and being free of macroscopic permanent deformation when subjected to a blunt instrument deformation test of at least about 4.0 lbs.

24. The insect screen according to claim 1, said insect screen having a total light transmission of at least 75% and being free of macroscopic permanent deformation when subjected to a blunt instrument deformation test of at least about 5.0 lbs.

25. The insect screen according to claim 1, said insect screen having a total light transmission of at least 80% and being free of macroscopic permanent deformation when subjected to a blunt instrument deformation test of at least about 1.0 lbs.

26. The insect screen according to claim 1, said insect screen having a total light transmission of at least 80% and being free of macroscopic permanent deformation when subjected to a blunt instrument deformation test of at least about 2.0 lbs.

27. The insect screen according to claim 1, said insect screen having a total light transmission of at least 80% and being free of macroscopic permanent deformation when subjected to a blunt instrument deformation test of at least about 3.0 lbs.

28. The insect screen according to claim 1, said insect screen having a total light transmission of at least 80% and being free of macroscopic permanent deformation when subjected to a blunt instrument deformation test of at least about 4.0 lbs.

29. The insect screen according to claim 1, said insect screen having a total light transmission of at least 80% and being free of macroscopic permanent deformation when subjected to a blunt instrument deformation test of at least about 5.0 lbs.

30. An insect screen comprising fibers, said insect screen having a visual clarity factor of at least 60% and being free of macroscopic permanent deformation when subjected to a blunt instrument deformation test of at least about 0.5 lbs.

31. The insect screen according to claim 30, said insect screen having a visual clarity factor of at least 60% and being free of macroscopic permanent deformation when subjected to a blunt instrument deformation test of at least about 1.0 lbs.

32. The insect screen according to claim 30, said insect screen having a visual clarity factor of at least 60% and being free of macroscopic permanent deformation when subjected to a blunt instrument deformation test of at least about 2.0 lbs.

33. The insect screen according to claim 30, said insect screen having a visual clarity factor of at least 60% and being free of macroscopic permanent deformation when subjected to a blunt instrument deformation test of at least about 3.0 lbs.

34. The insect screen according to claim 30, said insect screen having a visual clarity factor of at least 60% and being free of macroscopic permanent deformation when subjected to a blunt instrument deformation test of at least about 4.0 lbs.

35. The insect screen according to claim 30, said insect screen having a visual clarity factor of at least 60% and being free of macroscopic permanent deformation when subjected to a blunt instrument deformation test of at least about 5.0 lbs.

36. The insect screen of claim 30 wherein said fibers have a diameter equal to or less than about 0.007 inches.

37. The insect screen of claim 30 wherein said fibers have a diameter equal to or less than about 0.005 inches.

38. The insect screen of claim 30 wherein said fibers comprise a fluoropolymer.

39. The insect screen of claim 30 wherein said fibers comprise PVDF.

40. The insect screen of claim 30 further comprising a frame having a groove and spline construction, said fibers mounted in said frame.

41. The insect screen of claim 30 where said fibers are opaque.

42. The insect screen of claim 30 where said fibers are clear.

43. The insect screen of claim 30 where said fibers are dark in color.

44. The insect screen of claim 30 further comprising fibers in a warp and fill construction defining openings having a warp and fill dimension, at least one of said warp and fill dimensions being less than about 0.06 inches and the other of said warp and fill dimensions being larger than about 0.01 inches.

45. The insect screen according to claim 30, said insect screen having a visual clarity factor of at least 70% and being free of macroscopic permanent deformation when subjected to a blunt instrument deformation test of at least about 0.5 lbs.

46. The insect screen according to claim 30, said insect screen having a visual clarity factor of at least 70% and being free of macroscopic permanent deformation when subjected to a blunt instrument deformation test of at least about 1.0 lbs.

47. The insect screen according to claim 30, said insect screen having a visual clarity factor of at least 70% and being free of macroscopic permanent deformation when subjected to a blunt instrument deformation test of at least about 2.0 lbs.

48. The insect screen according to claim 30, said insect screen having a visual clarity factor of at least 70% and being free of macroscopic permanent deformation when subjected to a blunt instrument deformation test of at least about 3.0 lbs.

49. The insect screen according to claim 30, said insect screen having a visual clarity factor of at least 70% and being free of macroscopic permanent deformation when subjected to a blunt instrument deformation test of at least about 4.0 lbs.

50. The insect screen according to claim 30, said insect screen having a visual clarity factor of at least 70% and being free of macroscopic permanent deformation when subjected to a blunt instrument deformation test of at least about 5.0 lbs.

51. The insect screen according to claim 30, said insect screen having a visual clarity factor of at least 80% and being free of macroscopic permanent deformation when subjected to a blunt instrument deformation test of at least about 0.5 lbs.

52. The insect screen according to claim 30, said insect screen having a visual clarity factor of at least 80% and being free of macroscopic permanent deformation when subjected to a blunt instrument deformation test of at least about 1.0 lbs.

53. The insect screen according to claim 30, said insect screen having a visual clarity factor of at least 80% and being free of macroscopic permanent deformation when subjected to a blunt instrument deformation test of at least about 2.0 lbs.

54. The insect screen according to claim 30, said insect screen having a visual clarity factor of at least 80% and being free of macroscopic permanent deformation when subjected to a blunt instrument deformation test of at least about 3.0 lbs.

55. The insect screen according to claim 30, said insect screen having a visual clarity factor of at least 80% and being free of macroscopic permanent deformation when subjected to a blunt instrument deformation test of at least about 4.0 lbs.

56. The insect screen according to claim 30, said insect screen having a visual clarity factor of at least 80% and being free of macroscopic permanent deformation when subjected to a blunt instrument deformation test of at least about 5.0 lbs.

57. An insect screen comprising:
a) a frame; and
b) fibers comprising PVDF mounted in said frame, said fibers having a diameter equal to about 0.005 inches and disposed in a warp and fill construction defining openings having a warp and fill dimension, at least one of said warp and fill dimensions being less than about 0.06 inches and the other of said warp and fill dimensions being larger than about 0.01 inches,
wherein the insect screen has a total light transmission of at least 80% and is free of macroscopic permanent deformation when subjected to a blunt instrument deformation test of about 5 lbs. or less.

58. An insect screen comprising:
a) a frame; and
b) fibers comprising PVDF mounted in said frame, said fibers having a diameter equal to about 0.005 inches and disposed in a warp and fill construction defining openings having a warp and fill dimension, at least one of said warp and fill dimensions being less than about 0.06 inches and the other of said warp and fill dimensions being larger than about 0.01 inches,
wherein the insect screen has a visual clarity factor of at least about 75% and is free of macroscopic permanent deformation when subjected to a blunt instrument deformation test of about 5 lbs. or less.

59. A method of excluding insects from a space having an access comprising the steps of:
a) providing a frame comprising a groove and spline construction; mounting fibers in said frame in a warp and fill construction defining openings having a warp and fill dimension, at least one of said warp and fill dimensions being less than about 0.06 inches and the other of said warp and fill dimensions being larger than about 0.01 inches, to form a screen, said fibers comprising PVDF and having a diameter equal to about 0.005 inches, whereby the screen has a total light transmission of at least about 65% and is free of macroscopic permanent deformation when subjected to a blunt instrument deformation test of about 5 lbs. or less; and
b) covering the access with said screen,
whereby the insects are prevented from entering the space.

60. A method of excluding insects from a space having an access comprising the steps of:
a) providing a frame comprising a groove and spline construction;
b) mounting fibers in said frame in a warp and fill construction defining openings having a warp and fill dimension, at least one of said warp and fill dimensions being less than about 0.06 inches and the other of said warp and fill dimensions being larger than about 0.01 inches, to form a screen, said fibers comprising PVDF and having a diameter equal to about 0.005 inches, whereby the screen has a visual clarity factor of at least about 75% and is free of macroscopic permanent deformation when subjected to a blunt instrument deformation test of about 5.0 lbs. or less; and
c) covering the access with said screen,
whereby the insects are prevented from entering the space.
